(19) United States
(12) Patent Application Publication
(10) Pub. No.: US 2011/0146531 A1
(43) Pub. Date: Jun. 23, 2011

(54) BITUMINOUS COMPOSITIONS AND METHODS

(75) Inventor: Smarajit Mitra, West St. Paul, MN (US)

(73) Assignee: 3M Innovative Properties Company

(21) Appl. No.: 12/970,271

(22) Filed: Dec. 16, 2010

Related U.S. Application Data
(60) Provisional application No. 61/287,536, filed on Dec. 17, 2009.

(51) Int. Cl. C08L 95/00

(52) U.S. Cl. 106/18.26; 106/278; 106/18.11; 524/59

(57) ABSTRACT

Compositions including a bituminous material, and a solvent including at least one ester formed as the reaction product of a C₁-C₄ alcohol with a C₄-C₆ mono-carboxylic acid, and construction materials including the bituminous compositions. Methods of using the bituminous compositions in forming construction materials are also disclosed. The construction materials may be advantageously used as a roofing shingle, a roofing membrane, a roof coating, a paving material, a sealant, or a combination thereof. In certain exemplary embodiments, the composition forms a solar reflective surface.

### CROSS REFERENCE TO RELATED APPLICATION

This application claims the benefit of U.S. Provisional Patent Application No. 61/287,536, filed Dec. 17, 2009, the disclosure of which is incorporated by reference herein in its entirety.

### TECHNICAL FIELD

The present disclosure relates to bituminous compositions including a volatile solvent derived from natural or renewable raw materials. The disclosure further relates to methods of using such bituminous compositions in preparing construction materials, including solar reflective roofing materials.

### BACKGROUND

Solar reflective roof coatings are used extensively, particularly in flat or low slope roofs, to reduce heating of buildings by solar absorption, and thereby decrease the energy cost associated with keeping buildings cool in summer. Such coatings may also be useful for high slope roofs, since most high slope residential roofing in North America is constructed of asphalt shingles containing dark-colored mineral granules, and such dark surfaces generally absorb more heat than lighter-colored surfaces. Solar reflective roof coatings may also reduce the “urban heat island effect,” wherein the average air temperatures of urban areas become higher than the surrounding non-urban areas. Studies done in California and Florida (see e.g. H. Akbari, R. Levinson and S. Stern, Solar Energy, 82, 648-655 (2008)), estimate that with roofing solar reflectance increases from 10-20% to 60%, energy savings for building cooling can be cut by more than 20%.

For low slope or flat roofs, common on commercial and industrial buildings in North America and even residential buildings in other parts of the world, reflective surfaces are typically applied as membranes or coatings. The membranes can be asphalt-based with a highly reflective thermoplastic elastomeric sheet on the top. The coatings can be white polymeric emulsions (typically acrylic), or asphalt emulsions including reflective pigments.

Asphalt (i.e., bitumen) is the dark, hydrocarbon residue obtained from crude oil fractionation commonly used as a low cost binder in many coatings, sealants and membranes. Bituminous compositions are used extensively in manufacturing construction materials, for example, paving materials, roofing materials (e.g., shingles and membranes), industrial coatings and sealants for pipes, roofs, walls, floors, and the like. Bituminous bituminous compositions are particularly well-suited for use in roofing applications, due to asphalt's low cost, inherent waterproofing characteristics, advantageous outdoor weatherability, good flexibility, adhesion to many surfaces, and relative ease of application.

Although asphalt comes in many grades and types, its hydrocarbon nature allows for ready solubility in aromatic hydrocarbons. For this reason, bituminous compositions are often provided as mixtures in hydrocarbon solvents (e.g., Stoddard solvent) including aromatic hydrocarbons such as benzene, toluene, and xylene. In fact, most commercial bituminous compositions, including asphalt emulsions, contain at least some aromatic hydrocarbons.

Because such hydrocarbon solvents are typically derived from petroleum, they are generally regarded as non-renewable resources and further, environmental, health, and safety regulations may limit their manufacture, use or disposal.

### SUMMARY

In one aspect, the present disclosure describes a composition including a bituminous material, and a solvent including at least one ester formed as the reaction product of a C₁-C₄ alcohol with a C₄-C₆ mono-carboxylic acid. In some exemplary embodiments, the bituminous material is selected from asphaltum, natural asphalt, petroleum asphalt, liquid asphalt, blown asphalt, asphalt cement, or a mixture thereof. In certain exemplary embodiments, the bituminous material exhibits a Penetration determined using ASTM Test Method D-5 of at least 40 dmm.

In additional exemplary embodiments, the solvent exhibits a normal boiling point of from about 100° C. to about 165° C. In certain exemplary embodiments, the at least one ester is represented by the formula R—(C═O)—O—R % wherein R is CₙH2ₙ₊₂ and n=3-5; and R′ is CₘH₂ₘ₊₂ and m=1-4. In some particular exemplary embodiments, the at least one ester is selected from methyl butyrate, ethyl butyrate, propyl butyrate, isopropyl butyrate, n-butyl butyrate, iso-butyl butyrate, tert-butyl butyrate, methyl valerate, ethyl valerate, propyl valerate, isopropyl valerate, n-butyl valerate, iso-butyl valerate, tert-butyl valerate, methyl caproate, ethyl caproate, propyl caproate, isopropyl caproate, n-butyl caproate, iso-butyl caproate, tert-butyl caproate, and combinations thereof. In some particular embodiments, the amount of solvent in the composition is at least 50% by weight of the composition.

In further exemplary embodiments, the bituminous composition includes at least one co-solvent. In certain exemplary embodiments, the at least on co-solvent is selected from an aliphatic hydrocarbon, an aromatic hydrocarbon, methyl formate, ethyl formate, methyl acetate, ethyl acetate, n-propyl acetate, iso-propyl acetate, n-butyl acetate, iso-butyl acetate, tert-butyl acetate, n-pentyl acetate, amyl acetate, benzyl acetate, phenyl acetate, ethylphenyl acetate, ethyl propionate, ethyl butyrate, benzyl butyrate, amyl butyrate, methyl-isobutyrate, ethyl-isobutyrate, allyl caproate, ethyl valerate, methyl-isovalerate, ethyl-isovalerate, ethyl stearate, methyl-pivalate, ethyl-pivalate, ethyl benzoate, methyl salicylate, methyl anthranilate, and combinations thereof.

In other exemplary embodiments, the bituminous composition includes at least one additive selected from asphalt modifiers, curing agents, gelling agents, dehydrating agents, flame retardants, surfactants, fillers, pigments, reflective particles, fibrous materials, aggregate materials, and combinations thereof. In one particular exemplary embodiment, the at least one additive is selected to be reflective particles comprising aluminum metal. In certain exemplary embodiments, the reflective particles comprise 5-20% by weight of the composition. In additional exemplary embodiments, the bituminous composition further includes a fibrous material. In certain exemplary embodiments, the fibrous material comprises a polyolefin.

In another aspect, the present disclosure provides a construction material including any of the foregoing bituminous compositions. In some exemplary embodiments, the construction material is selected from a roofing shingle, a roofing membrane, a roof coating, a paving material, a sealant, and combinations thereof. In certain exemplary embodiments, the composition forms a solar reflective surface. In some particular exemplary embodiments, the solar reflective surface has a reflectivity of at least 25%.

In a further aspect, the present disclosure provides a method of using any of the foregoing bituminous compositions, comprising applying the composition to a surface, and removing at least a portion of the solvent from the composition to form a film of the bituminous material on the surface. In some exemplary embodiments, the surface is a construction surface.

Exemplary embodiments according to the present disclosure may have certain surprising and unexpected advantages over the art. For example, in some exemplary embodiments, the bituminous compositions and methods disclosed herein may advantageously provide a more environmentally benign or “green” composition suitable for use in producing a construction material, for example, a roofing shingle, a roofing membrane, a roof coating, a paving material, a sealant, a protective coating, and the like. Additional exemplary embodiments according to the present disclosure may exhibit lower toxicity and reduced fire potential relative to conventional bituminous compositions. Other exemplary embodiments according to the present disclosure may produce a lower cost bituminous composition. Certain particular exemplary embodiments according to the present disclosure may yield an asphalt-based construction material, for example, a roofing material (e.g., a roofing shingle, a roofing membrane, a roof coating, or a roofing sealant) having a surface which exhibits a higher solar reflectivity than conventional construction (e.g., roofing) materials.

Various aspects and advantages of exemplary embodiments of the exemplary embodiments of the present disclosure have been summarized. The above Summary is not intended to describe each illustrated embodiment or every implementation of the exemplary embodiments of the present disclosure. The Drawings and the Detailed Description that follow more particularly exemplify certain preferred embodiments using the principles disclosed herein.

### DETAILED DESCRIPTION

### Glossary

In this application:

The term “aggregate” as used herein is intended to include solid particles having a range of sizes including fine particles such as sand to relatively coarse particles, for example crushed stone, gravel, slag, or roofing granules.

The term “asphalt” as used herein refers to any of a variety of solid or semisolid materials at room temperature, which gradually liquefy when heated, and in which the predominant constituents are naturally occurring bitumens obtained, for example, as residues in petroleum refining. Asphalt is further defined by Kirk-Othmer, Encyclopedia of Chemical Technology, Vol. 3, Third Ed. (1978) pp. 284 327, John Wiley & Sons, New York. An additional discussion appears in the publication entitled “A Brief Introduction to Asphalt and some of its Uses”, Manual Series No. 5 (MS-5), The Asphalt Institute, 7th Ed., September, 1974.

The term “base asphalt” as used herein refers to any asphalt which does not contain any additives (e.g., polymer, sulfur, etc.).

Various exemplary embodiments of the disclosure will now be described. Embodiments of the present disclosure may take on various modifications and alterations without departing from the spirit and scope of the disclosure. Accordingly, it is to be understood that the embodiments of the present disclosure are not to be limited to the following described exemplary embodiments, but is to be controlled by the limitations set forth in the claims and any equivalents thereof.

The present disclosure generally relates to bituminous compositions including a volatile solvent derived from natural or renewable raw materials, and construction materials prepared using such renewable or “green” bituminous compositions. The disclosure broadly describes bituminous compositions including a bituminous material, and a solvent including at least one ester formed as the reaction product of a C₁-C₄ alcohol with a C₄-C₆ mono-carboxylic acid. Such esters are naturally present in a number of plant materials, or may be prepared using mono-carboxylic acids derived from animal fat.

Surprisingly, I have discovered that it is possible to use such a natural ester, derived from vegetable oils or animal fats, as a solvent in a bituminous composition, thereby replacing at least a portion of the hydrocarbon solvents (and particularly the aromatic solvents) typically used in conventional bituminous compositions. Thus, some embodiments of the disclosure provide bituminous compositions that reduce or eliminate the use of expensive, non-renewable, potentially toxic, potentially flammable, petroleum-based solvents, and replace them with renewable, naturally-derived volatile fatty ester solvents.

### Bituminous Materials

The bituminous materials which may be used in accordance with this disclosure include asphaltum, natural asphalt, petroleum asphalt, liquid asphalt, blown asphalt, petroleum tar, asphalt cement, or mixtures thereof. In certain exemplary embodiments, the bituminous material exhibits a Penetration determined using ASTM Test Method D-5 of at least 40 dmm.

The natural asphalts may include, for example, asphaltum such as Gilsonite, Grahamite and glance pitch; lake asphalt such as Trinidad asphalt; rock asphalt; or a mixture of two or more thereof. The petroleum asphalts may include straight asphalt obtained by distillation of a crude oil (unblown and substantially unoxidized), blown asphalt produced by blowing an oxygen-containing gas into a straight asphalt in the presence or absence of a catalyst, solvent-extracted asphalt obtained when asphaltic material is separated from the petroleum fraction containing it by the use of propane or other solvents, and cut-back asphalt which is a mixture of straight asphalt and a light petroleum solvent. Liquid asphalts are those asphalts which have been liquefied by blending with petroleum solvents.

The bituminous material may include petroleum tars. The petroleum tars may include oil gas tar obtained as a by-product when gases are produced from petroleum fractions, such tar in refined form, cut-back tar obtained by mixing a light petroleum fraction with such tar, and tar pitch obtained as a residue by removing the volatile fraction from such tar. For example, vacuum tower bottoms produced during the refining of conventional or synthetic petroleum oils are a common residue material useful as asphalt composition. Solvent deasphalting (SDA) bottoms may be used as part or all of the bituminous material of the bituminous composition.

SDA bottoms are obtained from suitable feeds such as vacuum tower bottoms, reduced crude (atmospheric), topped crude, and preferably hydrocarbons comprising an initial boiling point of about 450° C. (850° F.) or above. Preferably the solvent deasphalting bottoms are obtained from vacuum tower bottoms, preferably boiling above 538° C. (1000° F.). Solvent deasphalting can be carried out at temperatures of 93-148° C. (200-300° F.). After solvent deasphalting, the resulting SDA bottoms have a boiling point above 510° C. (950° F.), preferably above 540° C. (1000° F.). In some exemplary embodiments, the SDA bottoms that may be useful are characterized by a Penetration (ASTM Standard Method D-5), measured in tenths of a millimeter (dmm), of 0 to 70 dmm at 25° C. (77° F.), more preferably 10 to 60 dmm at 25° C. (77° F.), most preferably 40-50 dmm at 25° C. (77° F.).

In some exemplary embodiments, the bituminous material may be solely or partly material produced by distillation, without any solvent extracted step. Such material, sometimes referred to as “asphalt cement”, have a reduced viscosity of 100 to 5000 poises at 60° C. (140° F.), preferably 250 to 4000 poises. The viscosity of asphalt cement at 60° C. is typically more than about 65 poise. An asphalt cement component of reduced viscosity can be obtained from any suitable source, e.g., atmospheric distillation bottoms.

While any starting asphalt cement can be used, it is preferred to use a high quality material, most preferably one which is PG performance graded, e.g., PG-64-22 (or other comparable quality material, compatible with the same grades of asphalt used to make the roads) where the first number “64” represents the high pavement temperature in degrees Celsius while the second number “22” represents the low paving temperature. This high temperature relates to the effects of rutting and the low temperature relates to cold temperature and fatigue cracking.

The asphalt cements that may be useful are, in some exemplary embodiments, characterized by a Penetration (ASTM Standard Method D-5) of at least 50 dmm at 25° C. (77° F.), and more preferably, at most 400 dmm at 25° C. (77° F.), and a typical Penetration is from 50 to 300 dmm. In further exemplary embodiments, the bituminous material comprises a non-air blown solvent extracted asphalt having a Penetration (ASTM Standard Method D-5) of 40-150 dmm and a softening temperature of 105-130° F. (about 40-55° C.). In other exemplary embodiments, the bituminous material comprises the bituminous material comprises an air blown solvent extracted asphalt having a Penetration (ASTM Standard Method D-5) of 0-7 dmm and a softening temperature of 200-250° F. (about 93-121° C.).

Generally, the bituminous compositions of the present disclosure may contain bituminous material in any amount. In some exemplary embodiments, the bituminous composition contains at least 5% w/w, more preferably at least 10% w/w, even more preferably at least 15% w/w, most preferably at least 20% w/w, of bituminous material. In other exemplary embodiments, the bituminous composition contains bituminous material in an amount no greater than 50% w/w, more preferably no greater than 40% w/w, even more preferably no greater than 30% w/w, and most preferably no greater than 20% w/w of the bituminous composition. In certain other exemplary embodiments, it may be preferable to use less than 18% w/w of the bituminous material, with excellent results obtainable with less than 15% w/w, or even 10.0-12.5% w/w of the bituminous composition.

In some exemplary embodiments, the bituminous material may be added to the bituminous composition in amounts sufficient to provide the resulting bituminous composition with the desired viscosity for the intended application, e.g., 2000 poises at 60° C. (140° F.) for typical paving applications. For Performance Graded (PG) Applications, the bituminous compositions may preferably have a G*/sin delta value in excess of 1.0 kPa at temperatures between about 46 to about 82° C., more preferably 52 to 76° C. Preferred bituminous materials have an initial viscosity at 140° F. (60° C.) of 200 to 6000 poise. The initial Penetration range of the base asphalt at 77° F. (25° C.) is preferably 50 to 350 dmm, more preferably 50 to 200 dmm, when the intended use of the composition is road paving.

Any of the foregoing kinds of bituminous materials may be used singly or jointly in preparing a composition according to the present disclosure. Straight asphalt may preferably be useful for paving applications, and oxidized and blown asphalts may preferably be useful for roofing applications. An emulsion of any of the foregoing bituminous materials and the following ester solvents dispersed in water, and optionally including a small amount of a surfactant or other emulsifying agent as an additive, may also be used to form a bituminous composition (e.g. an asphalt emulsion) according to the present disclosure.

### Solvent

The solvent for the bituminous composition includes at least one ester formed as the reaction product of a C₁-C₄ alcohol (i.e. an alcohol containing 1-4 carbon atoms per molecule) with a C₄-C₆ mono-carboxylic acid (i.e. a carboxylic acid containing 4-6 carbon atoms per molecule, and including only a single carboxyl (COOH) group). The solvent may be a mixture of such esters. Typically these esters are made by the esterification of a mono-carboxylic acid with an alcohol, preferably methanol or ethanol. The esterification is typically acid-catalyzed, as is known in the art.

Naturally-derived or renewable esters are presently preferred. Short chain fatty esters are naturally occurring in plant life, and the corresponding mono-carboxylic acids (e.g., butyric acid and caproic acid) are found extensively in animal products. For example, methyl butyrate has a fruity odor like apples and pineapples, and it is present in small amounts in several plant products, notably in pineapple oil. It is produced by distillation of plant based essential oils or is manufactured from the natural fatty acid or its glycerides. It is used in food flavorings and perfumes. Methyl caproate is primarily derived from the free mono-carboxylic acid which is abundantly present in lower farm animals and from the corresponding glycerides in fats and oils.

In certain exemplary embodiments, the at least one ester is represented by the formula R—(C═O)—O—R % wherein R is CₙH2ₙ₊₂ and n=1-4; and R′ is CₘH₂ₘ₊₂ and m=3-5. In some particular exemplary embodiments, the at least one ester is selected from methyl butyrate, ethyl butyrate, propyl butyrate, isopropyl butyrate, n-butyl butyrate, iso-butyl butyrate, tert-butyl butyrate, methyl valerate, ethyl valerate, propyl valerate, isopropyl valerate, n-butyl valerate, iso-butyl valerate, tert-butyl valerate, methyl caproate, ethyl caproate, propyl caproate, isopropyl caproate, n-butyl caproate, iso-butyl caproate, tert-butyl caproate, and combinations thereof.

In some exemplary embodiments, the solvent preferably exhibits a normal boiling point of at most about 165° C., more preferably at most 150° C., still more preferably at most 140° C. In certain exemplary embodiments, the solvent preferably exhibits a normal boiling point of at least 100° C., more preferably at least 110° C., still more preferably at least 120° C. In other exemplary embodiments, the normal boiling point of the solvent ranges from about 100° C. to about 165° C., more preferably about 110° C. to about 150° C., still more preferably from about 120° C. to about 140° C.

The amount of solvent (excluding any optional co-solvent as described below) used in the bituminous compositions of the present disclosure may vary, although it is generally preferred that the bituminous composition include a high proportion of the renewable solvent.

In some exemplary embodiments, the solvent (excluding any optional co-solvent as described below) comprises at least 50% w/w, more preferably at least 60% w/w, even more preferably at least 70% w/w, and most preferably at least 80% w/w, of the bituminous composition. In certain presently preferred embodiments, the bituminous composition comprises from 80 to 99% solvent, more preferably 80 to 95% w/w solvent, even more preferably 80 to 90% w/w, and most preferably, 80 to 85% solvent, with the remainder being the bituminous material, and any optional additives, as described below.

### Optional Co-Solvents

In additional exemplary embodiments, the bituminous composition optionally includes at least one co-solvent. In certain exemplary embodiments, the at least on co-solvent is selected from an aliphatic hydrocarbon, an aromatic hydrocarbon, methyl formate, ethyl formate, methyl acetate, ethyl acetate, n-propyl acetate, iso-propyl acetate, n-butyl acetate, iso-butyl acetate, tert-butyl acetate, n-pentyl acetate, amyl acetate, benzyl acetate, phenyl acetate, ethylphenyl acetate, ethyl propionate, ethyl butyrate, benzyl butyrate, amyl butyrate, methyl-isobutyrate, ethyl-isobutyrate, allyl caproate, ethyl valerate, methyl-isovalerate, ethyl-isovalerate, ethyl stearate, methyl-pivalate, ethyl-pivalate, ethyl benzoate, methyl salicylate, methyl anthranilate, and combinations thereof. The presently preferred co-solvents are esters, more preferably esters of predominantly natural origin, as described above.

The amount of co-solvent used in the bituminous compositions of the present disclosure may vary, although it is generally preferred that the bituminous composition include a high proportion of the renewable ester solvent. Thus, in some exemplary embodiments, the co-solvent comprises at most 40% w/w, more preferably at most 30% w/w, even more preferably at most 250% w/w, and most preferably at most 20% w/w, of the bituminous composition. In certain presently preferred embodiments, the bituminous composition comprises from 5-40% w/w co-solvent, more preferably from 10-30% w/w co-solvent, even more preferably from 15-25% w/w co-solvent, and most preferably from 15-20% co-solvent, with the remainder being the bituminous material, the solvent ester, and any optional additives, as described below.

### Optional Additives

The bituminous composition may, in some exemplary embodiments, include, or have added to it, at least one additive selected from asphalt modifiers, curing agents, gelling agents, dehydrating agents, flame retardants, surfactants, fillers, pigments, reflective particles, fibrous materials, aggregate materials, and combinations thereof. Preferably, the renewable ester solvent is the primary, or even sole, material added to the bituminous composition.

Asphalt Modifiers

In some exemplary embodiments, an optional asphalt modifier (e.g., fluxing component or plasticizer for asphalt) may also be added, or may be present in the bituminous composition, to improve the flow properties of the bituminous composition and improve the penetration for a desired softening point. Suitable fluxing agents or plasticizers include polyolefin (co)polymers), polystyrene (co)polymers, and natural or synthetic rubbers, such as, for example, styrene-butadiene rubber (SBR). Other suitable asphalt modifiers are known in the art (see e.g. Kirk-Othmer, Encyclopedia of Chemical Technology, Vol. 3, Third Ed. (1978) pp. 284 327, John Wiley & Sons, New York.)

Curing, Gelling and Dehydrating Agents

In some exemplary embodiments, the viscoelastic properties of the bituminous composition may be further improved using an optional curing or gelling agent. The curing agent typically comprises a sulfur-donor compound. An extensive range of curing agents (e.g. sulfur crosslinking agents and sulfur-containing crosslinking agents) have been used for the purpose of “curing” bitumens. Sulfur has long been known to be added to bitumens to strengthen and accelerate the bitumen bonding and curing process. See, for example, U.S. Pat. Nos. 4,145,322 and 4,242,246.

The curing agent may further comprise vulcanisation accelerators, either with or without sulfur-donating features. Suitable vulcanisation accelerators are disclosed in U.S. Pat. No. 5,605,946, which is incorporated herein by reference in its entirety. In addition, other curing packages commonly used in the asphalt industry can be applied. However, it is presently preferred that the curing agent comprises sulfur, stearic acid or a salt thereof, zinc oxide and/or tetramethyl thiuram disulfide. Such a curing agent is commercially available under the trade name SURMAC® DO from Latexfalt B.V. (the Netherlands).

In other exemplary embodiments, an optional gelling agent may be added to the bituminous composition. The gelling agent may, in some embodiments, function both as a filler and a viscosity control agent, by forming a three-dimensional network upon mixing with the bituminous material. Suitable gelling agents include clays such as, for example, attapulgite, bentonite or sepiolite clays, although other similar functioning materials are probably acceptable and are intended to come within the scope of this disclosure. In certain exemplary embodiments, especially for high performance construction materials, the bituminous composition may contain an optional polymer or ground up rubber or some other “plastic” like material which can be dispersed or dissolved in the asphalt to swell and/or gel and thereby form a matrix. When such gelling agents are added, conventional techniques may be used to blend the gelling agent with the base asphalt.

In further exemplary embodiments, an optional dehydrating agent may be added to the bituminous composition. The optional dehydrating agent may which function to absorb or adsorb and thereby remove any residual water found in the bituminous composition. In particular, the presence of moisture in bituminous compositions containing aluminum particulates may be deleterious. Suitable dehydrating agents include colloidal anhydrous silica, colloidal anhydrous alumina, calcium chloride, calcium sulfate, and the like.

In some exemplary embodiments, the bituminous composition preferably comprises at least 0.01 to at most 5.0 wt. % of the curing, gelling or dehydrating agent, more preferably at least 0.02% to at most 2.5%, even more preferably at least 0.05% and at most 1% based on the total weight of the bituminous composition.

Surfactants

In some exemplary embodiments, an optional surface active agent or surfactant may be added to the bituminous composition. Suitable surfactants include anionic surfactants, cationic surfactants, zwitterionic surfactants, nonionic surfactants, and mixtures thereof. Exemplary anionic surfactants include, for example, long chain carboxylic and sulfonic acids. Exemplary cationic surfactants include, for example, the hydrochlorides of fatty diamines, imidazolines, ethoxylated amines, amido-amines and quaternary ammonium compounds. Exemplary non-ionic surfactants include, for example, ethoxylated alkyl phenols, ethoxylated alcohols and ethoxylated sorbitan esters. Fluorochemical surfactants may also be used advantageously. Typically, the surfactant may be added in an amount of at least 0.01 to at most 5.0 wt. %, more preferably at least 0.02% to at most 3%, even more preferably at least 0.05% and at most 2.5%, based on the total weight of the bituminous composition.

Fillers, Flame Retardants, and Pigments

The bituminous composition may, in some exemplary embodiments, include, or have added to it, at least one optional filler. The filler may, in some embodiments, comprise a flame retardant or a pigment. Mixtures of different fillers may also be used. Fillers in particulate form are presently preferred. Filler particles generally have an average particle size range between about 0.5 and about 500 micrometers. In some embodiments, the filler particle is between about 5 and about 20 micrometers.

Non-limiting examples of suitable fillers include: carbon black, fly ash, slate dust, limestone, dolomite, siliceous fillers (e.g. mica and other sheet silicates). metal carbonates (such as calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., sodium silicate, calcium silicate, calcium metasilicate, sodium aluminosilicate), metal sulfates (such as calcium sulfate, barium sulfate, sodium sulfate, aluminum sodium sulfate, aluminum sulfate), certain metal oxides (e.g., calcium oxide (lime), alumina, tin oxide (stannic oxide), titanium dioxide), metal sulfites (e.g., calcium sulfite), talc, clays (e.g., montmorillonite, bentonite), feldspar, gypsum, vermiculite, wood flour, perlite, aluminum trihydrate, and the like.

The filler may also be a metal filler. Examples of metal fillers include copper, tin, zinc, bismuth, cobalt, antimony, cadmium, iron, and titanium. Other miscellaneous fillers include sulfur, organic sulfur compounds, graphite, boron nitride, and metallic sulfides.

Flame retardant fillers, for example, sodium bicarbonate and aluminum hydrate, could comprise all or a portion of the filler. The bituminous composition may also be colored by adding colored fillers, for example pigments, thereto. The bituminous composition may also include an anticorrosion pigment. Exemplary suitable organic coloring pigments include carbon black and phthalocyanine blue; exemplary suitable inorganic coloring pigments include titanium oxide, ferric oxide, lead chromate, and zinc oxide; exemplary suitable anticorrosion pigments include lead oxide, calcium plumbate, zinc chromate, basic lead chromate, zinc molybdate and condensed zinc phosphate. The above mentioned examples of fillers are meant to be a representative showing of some useful fillers, and are not meant to encompass all useful fillers.

The fillers may be provided with a surface treatment. Preferably, the surface treatment makes the surface of the filler particles more oleophilic, more hydrophobic, or less hydrophilic. Examples of suitable surface treatments include silanes, siloxanes, and surfactants, particularly surfactants exhibiting a hydrophile-lipophile balance (HLB) of ten or less.

The amount of filler is typically more than 5% by weight, suitably less than 80% by weight, more preferably at least 10% to at most 75% by weight, more preferably at least 20% to at most 70% by weight, even more preferably at least 30% to at most 65% by weight based on the total weight of the bituminous composition.

Reflective Particles

In some exemplary embodiments, the bituminous bituminous composition comprises reflective particles so that the bituminous composition forms a solar reflective surface when applied to a construction material surface and dried to form a film. In certain embodiments, the solar reflective surface may exhibit a reflectivity of at least 25%, more preferably at least 30%, even more preferably at least 50%, still more preferably at least 75% or even 80% or higher.

In one particular exemplary embodiment, the at least one additive is selected to be reflective particles. In one presently preferred embodiment, the reflective particles comprise aluminum metal, more preferably aluminum metal particulates, even more preferably dispersed aluminum flake pigments. Suitable dispersed aluminum flake pigments may be obtained under the trade name SPARKLE SILVER from Silberline Manufacturing Company (Tamaqua, Pa.). These dispersed aluminum flake pigments are available at different average particle sizes and in varying concentrations dispersed in a carrier solvent.

In other exemplary embodiments, the bituminous bituminous composition comprises reflective particles so that the solar reflective surface exhibits a direct solar reflectance of at least about 20% at substantially all points in the wavelength range between 770 and 2500 nm. By direct solar reflectance is meant that fraction reflected of the incident solar radiation received on a surface perpendicular to the axis of the radiation within the wavelength range of 300 to 2500 nm as computed according to a modification of the ordinate procedure defined in ASTM Method G159.

In certain particular exemplary embodiments, reflective particulates or pigments may be used that have enhanced near infrared (NIR) reflectivity. These pigments include 10415 Golden Yellow, 10411 Golden Yellow, 10364 Brown, 10201 Eclipse Black, V-780 IR BRN Black, 10241 Forest Green, V-9248 Blue, V-9250 Bright Blue, F-5686 Turquoise, 10202 Eclipse Black, V-13810 Red, V-12600 IR Cobalt Green, V-12650 Hi IR Green, V-778 IR Brown-Black, V-799 Black, and 10203 Eclipse Blue Black (all available from Ferro Corp.,); and Yellow 193, Brown 156, Brown 8, Brown 157, Green 187B, Green 223, Blue 424, Black 411, Black 10C909 (all from Shepherd Color Co.). Additional pigments of interest, some displaying enhanced infrared light reflectivity, are discussed in Sliwinski et al., U.S. Pat. Nos. 6,174,360 and 6,454,848, both of which are incorporated herein by reference in their entirety.

In general, the amount of reflective particles added to the bituminous composition may vary with the particular material, although, in some exemplary embodiments, the concentration is preferably no more than about 30% w/w, more preferably no more than 25% w/w, more preferably no more than 20% w/w, and even more preferably no more than 15% w/w of the bituminous composition. In certain exemplary embodiments, the reflective particles comprise 1-30%, more preferably 2.5-25%, even more preferably 5-20% by weight of the bituminous composition.

Fibrous Materials

If desired, the bituminous composition may further comprise a fibrous material (e.g. fibers such as, for example, glass fibers, rock fibers, cellulose fibers, and/or polymeric fibers). In certain presently preferred embodiments, the fibrous material comprises polymeric fibers. The polymeric fibers preferably comprise a polyolefin, for example, polyethylene, polypropylene, polybutylene, combinations thereof, and the like. In general, the amount of fibrous material added to the bituminous composition may vary, although, in some exemplary embodiments, the concentration is preferably at least 1% and no more than about 25% w/w, more preferably at least 2.5% and no more than 20% w/w, more preferably at least 5% and no more than 15% w/w, and even more preferably from 5-10% w/w of the bituminous composition.

Aggregate Materials

One particularly preferred additive for bituminous compositions useful in paving or roofing applications is aggregate material, which may include gravel, stone, mineral granules, and the like. Suitable aggregate materials for paving applications include No. 6 crushed stone and finer aggregates such as No. 7 crushed stone, rough sand, fine sand, crushed sand, quartz sand and stone powder. These aggregates are typically mixed in amounts within the range of from 80 to 95% by weight, preferably 83 to 90% by weight of the total composition (i.e., bituminous composition plus aggregate). Such a mixing ratio may yield cured compositions with high physical strength.

One particular presently preferred aggregate material useful in manufacturing construction materials, in particular roofing materials such as shingles and roofing membranes, comprises roofing granules, available from 3M Company (St. Paul, Minn.). Presently preferred roofing granules, as well as methods of making roofing materials (e.g. shingles and roofing membranes) containing such granules are described in U.S. Pat. Nos. 6,881,701; 6,569,520; 7,455,899; and Published U.S. Pat. Application Pub. Nos. U.S. 2007/0218251, U.S. 2007/0218095, and U.S. 2008/0241550, the entire disclosures of which are incorporated herein by reference in their entireties.

### Methods of Using Bituminous Compositions

The present disclosure also provides, in some exemplary embodiments, a construction material including any of the foregoing bituminous compositions. In some exemplary embodiments, the construction material is selected from a roofing shingle, a roofing membrane, a roof coating, a paving material, a sealant, and combinations thereof. In certain exemplary embodiments, the composition forms a solar reflective surface. In some particular exemplary embodiments, the solar reflective surface has a reflectivity of at least 25%.

In further embodiments, the present disclosure provides a method of using any of the foregoing bituminous compositions, comprising applying the composition to a surface, and removing at least a portion of the solvent from the composition to form a film of the bituminous material on the surface. In some exemplary embodiments, the surface is a construction surface.

The processing techniques used to make bituminous compositions and/or asphalt emulsions are likewise well known and widely used. Additives may be blended into the bituminous composition using mixing procedures known in the art. The bituminous material may be in a fluid or molten condition during mixing. Any optional additives may be added to the bituminous composition using conventional methods, for example, by in-line mixing with the bituminous composition, or by adding the bituminous composition into an empty tank and mixing in the additive. When the bituminous material is a paving asphalt, the mixing temperature may desirably be in the range from about 250° F. (121° C.) to about 350° F. (177° C.), and in one embodiment from about 300° F. (149° C.) to about 340° F. (171° C.). When the bituminous material is a roofing asphalt, the mixing temperature may desirably be in the range from about 350° F. (177° C.) to about 480° F. (249° C.), and in one embodiment from about 380° F. (193° C.) to about 450° F. (232° C.).

The bituminous compositions of the present disclosure may, in some embodiments, be useful for preparing construction materials, for example, roofing or paving materials. Exemplary roofing materials include, for example, aggregate-containing bituminous compositions used to manufacture shingles, asphalt membranes, asphalt roof coatings, and asphalt sealants. Exemplary paving materials include aggregate-containing bituminous materials such as are employed in the paving of roads, bridges, airport runways, driveways, and the like.

For those construction materials advantageously containing aggregate, the bituminous compositions of the present disclosure may be mixed with the aggregate while in a fluid or molten condition. In some exemplary embodiments (e.g., fabrication of paving materials), the fluid or molten bituminous composition is mixed with preheated, pre-dried aggregate to form a substantially homogeneous mixture of uniformly coated aggregate, which may be used to form a paving material. In other exemplary embodiments (e.g., shingle fabrication), the fluid or molten bituminous composition may be applied to a substrate such as a reinforcing fabric or web, and the aggregate subsequently applied to the surface of the bituminous composition while still somewhat tacky.

In certain exemplary embodiments, the aggregate may be heated under conditions of time and temperature that are sufficient to drive off essentially all free moisture prior to mixing. During mixing, both the aggregate and the bituminous composition may be at temperatures of about 100° C. to about 160° C. Before the resulting composition is cooled to a temperature at which it loses its workability, it may be spread on a road bed, for example, and then compacted and permitted to cure. After curing, the resulting paving composition may comprise aggregate bound by a matrix of asphalt binder.

The asphalt compositions of the present disclosure may also be useful for preparing coatings or sealants (e.g., for roofing applications) or seal coats (e.g., for paving applications). A seal coat may be applied as a neat bituminous composition or as an emulsified asphalt. The seal coat may be applied at a rate of about 0.05 to about 0.8 gallons per square yard (about 0.23 to about 3.72 liters per square meter) of surface. In one embodiment, the application rate may be about 0.35 gallons per square yard (about 1.63 liters per square meter) of surface. The molten or fluid bituminous composition may be sprayed, for example, from a truck. Optionally, aggregate may be placed on top of the bituminous composition following application to a substrate or surface. Rolling or compacting the aggregate into the aggregate-containing bituminous composition may also be used effectively to finish the application.

The bituminous compositions of the present disclosure, after formation, may be handled by conventional techniques to maintain them in fluid or molten form under, for example, roofing or road-building conditions. For example, the bituminous compositions may be formed into a cutback asphalt by fluxing the bituminous composition with a suitable volatile solvent or distillate, preferably an ester solvent as provided herein. The cutback asphalt may then be directly mixed with aggregate and applied as a paving composition in fluid form, possibly at ambient temperatures. Another conventional technique for fluidizing the bituminous compositions prior to mixing with aggregate and forming into a paving composition may be to emulsify the bituminous composition with water using known techniques. One advantage of this method of fluidizing may be that after mixing with the aggregate, it may be applied as a paving composition at ambient temperature.

Asphalt Emulsions

Asphalt emulsions can be made with no liquid hydrocarbon component, but some varieties, especially medium setting (or breaking) emulsions contain a significant liquid hydrocarbon component. In general, use of liquid hydrocarbon oil in asphalt emulsions is desirably minimized, to reduce or eliminate volatile organic compounds (VOC's) and reduce the potential for formation of a separate oil phase, which can run off the road and foul the environment. Thus, in certain exemplary embodiments, the best use of solvent esters as described above will be to replace, or at least reduce the amount of, conventional liquid hydrocarbon oils derived from petroleum used in the asphalt emulsion. Thus, in some embodiments, asphalt emulsions may also be desirably formed as a dispersion of the bituminous compositions as described above, in water.

However, in certain exemplary embodiments, the solvent used in the bituminous composition may play an important role in helping to form and stabilize the emulsion. While partial or complete replacement of liquid hydrocarbons in asphalt emulsions is an excellent use of the bituminous compositions of the present disclosure, the solvent may also be used in asphalt emulsions not previously containing a liquid petroleum component.

In other exemplary embodiments, the asphalt emulsion will preferably contain sufficient amounts of conventional emulsifiers, or oils which serve that purpose (e.g., tall oil) to stabilize the emulsion. The particular emulsifier or surfactant chosen (e.g. cationic, anionic, zwitterionic, or nonionic) is known to those skilled in the art.

Most of the emulsion manufacturing process is conventional, well known, and need not be changed. The starting asphalt, the grinding/emulsification process, the use various surfactants (anionic, cationic or nonionic, as desired) can be conventional. More details of asphalt emulsions, emulsifiers, use of hard or soft asphalt, rapid or slow setting, and the like, may be obtained from the Asphalt Emulsion Manufacturing Association, found at http://www.aema.org/.

### Advantages of Exemplary Presently Disclosed Bituminous Compositions

Exemplary embodiments according to the present disclosure have surprising and unexpected advantages over the art. For example, exemplary embodiments according to the present disclosure may exhibit lower toxicity and reduced fire potential relative to conventional bituminous compositions. Other exemplary embodiments according to the present disclosure may produce a lower cost bituminous composition.

Additionally, in some exemplary embodiments, the bituminous compositions and methods disclosed herein advantageously provide a more environmentally benign or “green” composition suitable for use in construction applications as, for example, paving materials, roofing materials (e.g., shingles and membranes), industrial coatings and sealants for pipes, roofs, walls, floors, and the like.

In some embodiments, use of renewable solvent-based bituminous compositions according to the present disclosure, especially when applied relatively hot, creates a new class of construction materials, with lower toxicity and flammability, approaching that of neat asphalt cement, but which may not require the amount of heating required for a conventional hot mix application. The bituminous composition may exhibit lower VOC emissions, similar to slow cure asphalts, but a rapid “set up” time heretofore associated with medium cure or fast cure asphalts. The bituminous composition may be used in any application where conventional, hydrocarbon-based bituminous compositions were used.

Certain presently preferred exemplary embodiments according to the present disclosure yield an asphalt-based construction material, for example, a roofing shingle, a roofing membrane, or a roof coating, having a surface which exhibits a higher reflectivity than conventional construction materials. Furthermore, some exemplary embodiments of the present disclosure provide bituminous reflective coatings for construction (e.g. roofing) applications that are significantly higher in reflectivity than those commonly available in this category in the market, and which meet newer reflectivity standards for “cool roofing” (see e.g., Energy Star® 65%, CA Title 24 70%, LEED® 65%) not achievable by conventional bituminous roof coatings.

Additionally, while the bituminous compositions of the present disclosure are useful to replace conventional bituminous compositions including a high proportion of non-renewable liquid petroleum solvents, it is also within the contemplated scope of the present disclosure that there are many more uses for “green” bituminous compositions, especially in construction applications (e.g., paving) where conventional bituminous compositions or asphalt emulsions derived therefrom are encountering increasing regulatory pressure due to the presence of aromatic hydrocarbons. Furthermore, in the case of asphalt emulsions, where a totally aromatic solvent-free product may not be satisfactory in terms of application performance, but where such a product may be required by local laws or regulations, it may be possible to improve the performance of these emulsions by using bituminous compositions of the present disclosure in formulating the asphalt emulsion.

Exemplary embodiments of bituminous compositions and methods of making and using such compositions are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. In addition, the following abbreviations and materials are used in the Examples below:

### Bituminous Compositions

Exemplary bituminous compositions including a bituminous material and a solvent including at least one ester formed as the reaction product of a C₁-C₄ alcohol with a C₄-C₆ mono-carboxylic acid, were prepared and evaluated as described in the Examples.

### Materials:

Bituminous Materials

The bituminous materials used in the Examples are listed in Table 1.

Solvents

The solvents and co-solvents used in the Examples are listed in Table 2. Unless otherwise noted, all solvents and co-solvents used herein were obtained from Sigma Aldrich Chemical Co. (St. Louis, Mo.).

TABLE 1

| Abbreviation | Description |
|---|---|
| A1 | Asphalt powder, CAS No. 8052-42-4, obtained as |
| | “asphaltum” from City Chemical Corporation |
| | (Jersey City, NJ) |
| A2 | Asphalt, roofing grade, obtained as “TRUMBULL 4110” |
| | from Owens Corning Roofing and Asphalt LLC |
| | (Toledo, OH) |
| A3 | Asphalt, paving grade, obtained as “PG5828” from |
| | Flint Hills Resources (Wichita, KS) |

TABLE 2

| | | | | Normal |
|---|---|---|---|---|
| | | Alcohol | Acid | Boiling |
| Abbreviation | Ester | Carbon # | Carbon # | Point (C.°) |
| S1 | Butyl Butyrate | 4 | 4 | 164-165 |
| S2 | Iso-butyl Butyrate | 4 | 4 | 157-158 |
| S3 | Butyl Isobutyrate | 4 | 4 | 156-158 |
| S4 | Propyl Butyrate | 3 | 4 | 142-143 |
| S5 | I-propyl Butyrate | 3 | 4 | 130-131 |
| S6 | Ethyl Butyrate | 2 | 4 | 120 |
| S7 | Methyl Butyrate | 1 | 4 | 102-103 |
| S8 | Butyl Valerate | 4 | 5 | 186-187 |
| S9 | Propyl Pentanoate | 3 | 5 | 142-143 |
| S10 | Ethyl Valerate | 2 | 5 | 144-145 |
| S11 | Methyl Valerate | 1 | 5 | 128 |
| S12 | Butyl Caproate | 4 | 6 | 207-208 |
| S13 | Propyl Caproate | 3 | 6 | 187 |
| S14 | Ethyl Caproate | 2 | 6 | 165-167 |
| S15 | Methyl Caproate | 1 | 6 | 151 |
| S16 | Methyl Oleate | 1 | 18 | 186 |
| S17 | Methyl Linoleate | 1 | 18 | 192 |

A 40% w/w solution of A1 was made in toluene, and was used as a control sample for solubility and coating tests of renewable ester-based bituminous compositions.

### Test Methods:

Solubility

To qualitatively evaluate the solubility of asphalt in a candidate renewable solvent, Asphalt A1 was mixed at 40% w/w with the candidate solvent in a sealed container and placed in a hot water bath maintained at 55-65° C.) with frequent stirring for one hour, after which solubility was assessed by visually observing the relative amount of undissolved sediment in the container after cessation of stirring. The term “soluble” denotes that no undissolved sediment was observed; the term “partially soluble” denotes that some (generally less than about 5% by volume of the initial asphalt material) undissolved sediment was observed; the term “slightly soluble” denotes that more (generally more than about 5% but less than about 75% by volume of the initial asphalt material) undissolved sediment was observed; the term “insoluble” denotes that essentially all of the initial asphalt material was observed as undissolved sediment. The results of the qualitative solubility tests are summarized in Table 3.

To quantitatively evaluate the solubility of asphalt in a candidate renewable solvent, Asphalt A1 was mixed at varying weight percentages with the candidate solvent in a sealed container and placed in a hot water bath maintained at 55-65° C.) with frequent stirring for one hour, after which solubility was assessed by visually observing the relative amount of undissolved sediment in the container after cessation of stirring, as described above. The results of the quantitative solubility tests are summarized in Tables 4-9.

Coating Uniformity and Drying Rate:

Exemplary bituminous compositions were dip coated on glass slides and dried in an oven at 54° C. overnight. The dried coatings were then visually compared to a coating prepared by dip coating a glass slide in the control sample prepared as a 40% w/w solution of A1 in toluene. The results of the coating uniformity and drying rate tests are summarized in Table 4.

TABLE 3
Summary of Qualitative Solubility Tests
(Comparative Examples)

| | Insoluble/ | |
|---|---|---|
| | Slightly | |
| Solvent | soluble | Soluble |
| Diethyl Oxalate (Comparative) | X | |
| Diethylene Glycol Monomethyl Ether (Comparative) | X | |
| N-Methyl Pyrrolidone (Comparative) | X | |
| Methyl Oleate S16 (Comparative) | | X |
| Methyl Linoleate S17 (Comparative) | X | |

TABLE 4
Quantitative Solubility Tests (Examples)

| Example | Asphalt | Solvent | 10% w/w solubility | 20% w/w solubility |
|---|---|---|---|---|
| 1 | A2 | S1 | Yes (dries slowly) | Yes (dries slowly) |
| 2 | A2 | S4 | Yes | Yes |
| 3 | A2 | S6 | Yes | Partial |
| 4 | A2 | S7 | Yes | No |
| 5 | A2 | S8 | Yes (dries slowly) | Yes (dries slowly) |
| 6 | A2 | S10 | Yes | Yes |
| 7 | A2 | S11 | Yes | Yes |
| 8 | A2 | S14 | Yes (dries slowly) | — |

TABLE 5
Quantitative Solubility Tests with Asphalt A1 in Methyl Oleate (S16)
Example 9 (Comparative)

| | | | | | | |
|---|---|---|---|---|---|---|
| Asphalt A1 | 1% | 2.5% | 5% | 7.5% | 10% | 12.5% |
| Amount (% w/w) | | | | | | |
| Solubility | Soluble | Soluble | Soluble | Slightly | Slightly | Slightly |
| | | | | Soluble | Soluble | Soluble |

TABLE 6
Quantitative Solubility Tests with Asphalt A1 in Methyl Oleate (S16)/Toluene
Mixtures Example 10

| | | | | | | | | | | |
|---|---|---|---|---|---|---|---|---|---|---|
| Toluene | 1% | 2.5% | 5% | 7.5% | 10% | 15% | 17.5% | 20% | 22.5% | 25% |
| Amount (% w/w) | | | | | | | | | | |
| Solubility (7.5% w/w | PS | PS | PS | PS | PS | PS | PS | PS | S | S |
| Asphalt A1) | | | | | | | | | | |

(S = soluble PS = Partially soluble)

TABLE 7
Quantitative Solubility Tests with Asphalt A2 in Methyl Oleate (S16)
Example 11 (Comparative)

| | | | | | | |
|---|---|---|---|---|---|---|
| Asphalt A2 | 1% | 5% | 10% | 15% | 20% | 25% |
| Content (% w/w) | | | | | | |
| Solubility | Soluble | Soluble | Soluble | Soluble | Soluble | Soluble |

TABLE 8
Asphalt A2 in Methyl Butyrate (S7)
Example 12

| | | | | |
|---|---|---|---|---|
| Asphalt Content (% w/w) | 5% | 10% | 20% | 40% |
| S7 Content (% w/w) | 95% | 90% | 80% | 60% |
| Solubility | Soluble | Soluble | Soluble | Soluble |

TABLE 9
Asphalt A2 in Methyl Caproate (S15):
Example 13

| | | | | |
|---|---|---|---|---|
| Asphalt Content (% w/w) | 5% | 10% | 20% | 40% |
| S15 Content (% w/w) | 95% | 90% | 80% | 60% |
| Solubility | Soluble | Soluble | Soluble | Soluble |

When the 25% methyl oleate solution was dip coated on glass slides and dried overnight in an oven at 54° C. (as an accelerated test for ambient outdoor drying over a longer period of time) and compared with similar coatings with 40% asphalt A2 in toluene as a standard, it was determined that the toluene coating dried to a dry asphalt coat but the methyl oleate coating remained very wet. Although methyl oleate is a good solvent for asphalt A2, the resulting bituminous composition has a drying rate that is undesirably slow for typical ambient temperature application conditions (e.g. 0-40° C.). However, methyl oleate may still be used for higher temperature application or drying conditions (e.g. greater than 40° C.), or when drying under reduced ambient pressure (e.g. in a manufacturing process for roofing materials such as, for example, shingles or roofing membranes). Methyl oleate may also be a suitable co-solvent for use in the bituminous composition in low amounts, as described above.

Coating carrier media were tested with S7 and S15. Surprisingly, complete solubility of asphalt A2 could be obtained with these two solvents, even up to 40% w/w content of asphalt A2 in these bituminous compositions. These coating mixtures at 20% w/w and 40% w/w Asphalt 2 content were coated on glass slides and dried in an oven at 54° C. overnight. The dried coatings were equivalent to toluene-based coatings.

### Reflective Roofing Materials

### Materials:

Bituminous Materials

The bituminous material used for these formulations was asphalt A2 as described in Table 1 above. Other suitable bituminous materials may also be used in these compositions.

Solvents and Co-Solvents

The solvents used for these formulations were esters formed as the reaction product of a C₁-C₄ alcohol with a C₄-C₆ mono-carboxylic acid, for example, S7 (methyl butyrate) and S15 (methyl caproate), as described in Table 2 above. Various mixtures of these solvents were also tried with other co-solvents, and compared to the control sample prepared as a 40% w/w solution of A1 in toluene, as well as to a representative commercially available reflective roof coating product, Henry HE 555, available from Henry Company (El Segundo, Calif.).

Additives

Reflective Particulates

The aluminum flake pigments used as reflective particulates (i.e. particles) in the following examples are non-leafing pigments, designated as SPARKLE SILVER, and obtained from Silberline Manufacturing Company (Tamaqua, Pa.). These pigments come in different average particle sizes and in different concentrations dispersed in a carrier solvent. The pigment dispersions used to introduce reflective aluminum particles into the bituminous compositions in these examples are listed in Table 10.

TABLE 10

| | | Median | | |
|---|---|---|---|---|
| | | Particle | | Pigment |
| Pigment | | Diameter | | Amount |
| Dispersion | Designation | (Microns) | Solvent | (% w/w) |
| Sparkle Silver | SS1 | 55 | High Aromatic | 70% |
| 2750 | | | Mineral Oil | |
| Sparkle Silver | SS2 | 34 | High Aromatic | 80% |
| Premier 055 | | | Mineral Spirits | |
| Sparkle Silver | SS3 | 24 | High Aromatic | 70% |
| Premier 354 | | | Mineral Spirits | |
| Sparkle Silver | SS4 | 14 | High Aromatic | 64% |
| 5500 | | | Mineral Spirits | |

Fibrous Materials

The fibrous materials added to the bituminous compositions in these examples are designated as Short Stuff® and manufactured by MiniFibers, Inc. (Johnson City, Tenn.). Three different fluffed and dried polyethylene pulps were used, as listed in Table 11.

TABLE 11

| | | Median Fiber Length | Median Fiber Diameter |
|---|---|---|---|
| Pulp | Designation | (mm) | (microns) |
| ESS2F | P1 | 0.6 | 5 |
| ESS5F | P2 | 0.1 | 5 |
| E380F | P3 | 0.55-0.80 | 15 |

Illustrative bituminous compositions were prepared as listed in Table 12, and coated as described above. The illustrative bituminous compositions comprise asphalt, aluminum flake pigments, fibrous materials made of polyolefin (i.e. synthetic pulp), and a selected solvent.

Each of the bituminous compositions was dip coated onto a glass slide and dried in an oven at 50° C. overnight. For comparison, a commercial asphalt/Al-based reflective roof coating, Henry 555 Brilliant Aluminum Roof Coating, was similarly dip coated onto a glass slide and dried under the same condition.

All of the coatings of the examples were somewhat stained, giving a golden hue to the reflective coatings as compared to the commercial sample, which was more grayish-silver. The coatings were progressively more stained as the particle size of the A1 pigments increased. The nature of the solvent (S7 vs. S15) had no discernible effect on the appearance of the coatings and the toluene-based coating (Comparative Example 22) had the same color and appearance as the Examples prepared using renewable solvents (Examples 14-21).

TABLE 12
Effect of Aluminum Pigment Type and Solvent

| | Asphalt | | | | | |
|---|---|---|---|---|---|---|
| | A2 | | Solvent | | Dispersion | |
| Exam- | Amount | | Amount | | Amount | |
| ple | (% w/w) | Solvent | (% w/w) | Pigment | (% w/w)* | Stain** |
| 14 | 34 | S7 | 51 | SS4 | 15 | 1 |
| 15 | 34 | S7 | 52 | SS3 | 14 | 2 |
| 16 | 35 | S7 | 53 | SS2 | 12 | 3 |
| 17 | 35 | S7 | 52 | SS1 | 13 | 4 |
| 18 | 34 | S15 | 51 | SS4 | 15 | 1 |
| 19 | 34 | S15 | 52 | SS3 | 14 | 2 |
| 20 | 35 | S15 | 53 | SS2 | 12 | 3 |
| 21 | 35 | S15 | 52 | SS1 | 13 | 4 |
| 22 | 34 | Toluene | 51 | SS4 | 15 | 1 |
| Com- | | | | | | |
| parative | | | | | | |

*These are concentrations of the dispersed pigment as obtained. To calculate actual aluminum metal content, the factor for pigment concentration in each dispersion would have to be accounted for.
**Stain: 1 = lightest, 4 = darkest

The bituminous compositions of Table 13 were prepared, dip coated onto glass slides, and dried in an oven at 50° C. overnight. By visual examination, the results clearly indicated that as the amount of aluminum pigment in the coatings increased, the coatings were less stained and more reflective.

TABLE 13
Effect of Aluminum Pigment Concentration on Reflectivity

| | Asphalt | | Solvent | SS4 Dispersion | Aluminum |
|---|---|---|---|---|---|
| | Amount | | Amount | Amount | Amount |
| Example | (% w/w) | Solvent | (% w/w) | (% w/w) | (% w/w) |
| 23 | 42.5 | S7 | 42.5 | 15.0 | 10 |
| 24 | 39.4 | S7 | 39.1 | 21.5 | 14 |
| 25 | 36.1 | S7 | 36.1 | 27.8 | 18 |
| 26 | 42.7 | S15 | 42.6 | 14.7 | 9 |
| 27 | 39.2 | S15 | 39.2 | 21.6 | 14 |
| 28 | 36.1 | S15 | 35.9 | 28.0 | 18 |

The bituminous compositions of Table 14 were prepared, dip coated onto glass slides and dried in an oven at 50° C. overnight. By visual examination, the results showed that irrespective of the carrier solvent, at constant levels of Al pigment, the lower level of asphalt gave a more silvery reflective coating.

TABLE 14
Effect of Asphalt Concentration on Reflectivity

| | Asphalt | | | | |
|---|---|---|---|---|---|
| | A2 | | Solvent | SS4 Dispersion | Aluminum |
| | Amount | | Amount | Amount | Amount |
| Example | (% w/w) | Solvent | (% w/w) | (% w/w) | (% w/w) |
| 29 | 28.8 | S7 | 43.1 | 28.1 | 18 |
| 30 | 28.8 | S15 | 43.2 | 28.0 | 18 |

The bituminous compositions of Table 15 were prepared, dip coated onto glass slides and dried in an oven at 50° C. overnight. By visual examination, the results showed that the larger pigment size (SS1) gave more staining, but yielded a more reflective surface than the smaller particle size (SS4).

TABLE 15
Effect of Aluminum Pigment Particle Size on Reflectivity

| | Asphalt | | | | |
|---|---|---|---|---|---|
| | A2 | | Solvent | Ss1 Dispersion | Aluminum |
| | Amount | | Amount | Amount | Amount |
| Example | (% w/w) | Solvent | (% w/w) | (% w/w) | (% w/w) |
| 31 | 29.5 | S15 | 44.5 | 26.0 | 18 |

### Use of Optional Co-solvent

In some exemplary embodiments, in order to obtain bituminous compositions with more rapid drying rate and/or lower overall cost, relatively inexpensive, volatile co-solvents (e.g. ethyl acetate and ethyl propionate) were also evaluated as co-solvents in the bituminous compositions. Ethyl acetate is significantly more volatile than an ester formed as the reaction product of a C₁-C₄ alcohol with a C₄-C₆ mono-carboxylic acid, and thus would be expected to provide a shorter drying time. Ethyl acetate is thus preferable as a co-solvent. At the 3:2 solvent/asphalt ratios optimized above, the solubility of the bituminous composition with ethyl acetate as a co-solvent was evaluated, as summarized in Table 16. These results indicate that a 40/60 w/w ratio of ethyl acetate to S7 or S15 would be a good candidate for a lower cost, faster drying rate bituminous composition containing a co-solvent.

TABLE 16
Use of Co-solvent (Ethyl Acetate)

| | Asphalt A2 | | Ester | Ethyl Acetate | |
|---|---|---|---|---|---|
| | Amount | | Amount | Amount | |
| Example | (% w/w) | Ester | (% w/w) | (% w/w) | Solubility |
| 32 | 40 | S7 | 48 | 12 | Soluble |
| 33 | 40 | S7 | 36 | 24 | Soluble |
| 34 | 40 | S7 | 24 | 36 | Insoluble |
| 35 | 40 | S7 | 12 | 48 | Insoluble |
| 36 | 40 | S15 | 48 | 12 | Soluble |
| 37 | 40 | S15 | 36 | 24 | Soluble |
| 38 | 40 | S15 | 24 | 36 | Insoluble |
| 39 | 40 | S15 | 12 | 48 | Insoluble |

### Use of Optional Fibrous Material Additive

The bituminous compositions of Table 17 were prepared, dip coated onto glass slides and dried in an oven at 50° C. overnight. By visual examination, the results showed that the addition of the fibers surprisingly reduced the level of stain and discoloration of the coatings, and they appeared more silvery gray and reflective. These bituminous compositions also had higher viscosity and better coatability. Examples 43-45, with methyl caproate (S15) and ethyl acetate as a co-solvent, and with a slightly higher level of fibrous material contained therein, gave brighter and more silvery appearing and reflective coatings than did Example 42. However, these coatings were somewhat uneven.

Examples 46-48 were made with the pulp level reduced back to the amount used in Example 42. Of Examples 46-48, the Example with the smallest pulp fiber diameter (Example 46 using P2) exhibited the best overall appearance, with good surface smoothness and homogeneity, high reflectivity, and bright silver appearance.

TABLE 17
Effect of Polyolefin Fiber (Pulp) Additive

| | | | Ethyl | | SS1 | |
|---|---|---|---|---|---|---|
| | Asphalt A2 | Ester & | Acetate | Pulp & | Dispersion | |
| | Amount | Amount | Amount | Amount | Amount | |
| Example | (% w/w) | (% w/w) | (% w/w) | (% w/w) | (% w/w) | Comments |
| 40 | 37.5 | S7 | 22.5 | P2 | 0 | Addition of P2 |
| | | 33.7 | | 6.2 | | pulp at this level |
| | | | | | | produced semi- |
| | | | | | | solid mass; no |
| | | | | | | SS1 was added |
| 41 | 39.2 | S7 | 23.2 | P1 | 0 | Addition of P1 |
| | | 34.9 | | 2.7 | | pulp at this level |
| | | | | | | still produced an |
| | | | | | | unacceptably |
| | | | | | | thick solution; no |
| | | | | | | SS1 was added |
| 42 | 28.9 | S7 | 17.2 | P3 | 27.1 | This produced a |
| | | 25.8 | | 0.9 | | coatable mixture |
| 43 | 28.6 | S15 | 17.2 | P2 | 27.1 | With S15, the |
| | | 25.7 | | 1.5 | | higher level of |
| | | | | | | pulp was |
| | | | | | | tolerated |
| 44 | 28.6 | S15 | 17.1 | P1 | 27.1 | With S15, the |
| | | 25.7 | | 1.5 | | higher level of |
| | | | | | | pulp was |
| | | | | | | tolerated |
| 45 | 28.6 | S15 | 17.1 | P3 | 27.2 | With S15, the |
| | | 25.7 | | 1.5 | | higher level of |
| | | | | | | pulp was |
| | | | | | | tolerated |
| 46 | 27.6 | S15 | 20.3 | 1.0 | 26.2 | The level of pulp |
| | | 24.9 | | | | was reduced and |
| | | | | | | the ethyl acetate |
| | | | | | | was optimized |
| 47 | 27.7 | S15 | 20.2 | P2 | 26.3 | The level of pulp |
| | | 24.9 | | 0.9 | | was reduced and |
| | | | | | | the ethyl acetate |
| | | | | | | was optimized |
| 48 | 27.7 | S15 | 20.3 | P3 | 26.2 | The level of pulp |
| | | 24.9 | | 0.9 | | was reduced and |
| | | | | | | the ethyl acetate |
| | | | | | | was optimized |

### Reflectivity Measurements

Having optimized the bituminous composition based on visual appearance of the coated material as described above, additional dip coatings were made on clear glass substrates, and dried in an oven at 50° C. overnight. After drying, the solar reflectivities of the coated glass slides were measured made using a Solar Spectrum Reflectometer (Devices & Services Co., Dallas, Tex.). Using the ratios of Example 46 with SS1 as the source of reflective aluminum particles, P2 as the source of fibrous polyolefin material, and varying only the Aluminum particle content and solvent amount, the results shown in Table 18 were obtained.

TABLE 18

| | | Aluminum | |
|---|---|---|---|
| | | Pigment Amount | Reflectivity |
| Example | Solvent | (% w/w) | (%) |
| 49 Henry HE 555 | Stoddard Solvent | 10-30 | 24.6 |
| Comparative | | | |
| 50 | S15/Ethyl Acetate | 10 | 36.5 |
| 51 | S15/Ethyl Acetate | 20 | 58.0 |
| 52 Comparative | Toluene | 20 | 50.2 |

The bituminous compositions of Table 18 exhibit a reflectivity at least about 50% higher than the commercial sample benchmark (Henry HE 555), and in some cases

(Example 51) more than 100% higher. The bituminous composition of this disclosure made in toluene (Comparative Example 52) was also about 100% higher in reflectivity. The bituminous composition of Example 51 was coated at 25 mil (625 micrometers) wet thickness on a steel and an aluminum plate and dried, and the reflectivities of the dried compositions were measured as 58.3% anD-59.1% respectively.

### Effect of Coating Thickness on Reflectivity

Using the solar reflective bituminous composition of Example 51, additional dip coatings were made on clear glass substrates, and dried in an oven at 50° C. overnight. The wet coating thickness vs. reflectivity was measured on the glass. The results are summarized in Table 19.

TABLE 19
Effect of Coating Thickness on Reflectivity
Example 53

| Wet Film Thickness Mils (microns) | Reflectivity (%) |
|---|---|
| 10 (250) | 54.8 |
| 15 (375) | 59.3 |
| 20 (500) | 64.0 |
| 25 (625) | 61.6 |
| 30 (750) | 61.0 |
| 40 (1,000) | 58.6 |
| 50 (1,250) | 57.6 |

Over the entire range of coating thicknesses evaluated, the measured reflectivities of the exemplary coatings obtained with the composition of Example 51 were at least 100-150% higher than the measured reflectivity of Comparative Example 49 obtained using the commercial bituminous composition (Henry HE 555) coated on glass.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g. 1 to 5 includes 1, 1.5, 2, 2.75, 3, 3.80, 4, and 5). In addition, all numbers used herein are assumed to be modified by the term ‘about’. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following claims.

What is claimed is:

1. A composition comprising:
a bituminous material; and
a solvent comprising at least one ester formed as the reaction product of a C₁-C₄ alcohol with a C₄-C₆ mono-carboxylic acid.

2. The composition of claim 1, wherein the bituminous material is selected from asphaltum, natural asphalt, petroleum asphalt, liquid asphalt, blown asphalt, asphalt cement, or a mixture thereof.

3. The composition of claim 2, wherein the bituminous material exhibits a Penetration determined using ASTM Test Method D-5 of at least 40 dmm.

4. The composition of claim 1, wherein the solvent exhibits a normal boiling point from about 100° C. to about 165° C.

5. The composition of claim 1, wherein the at least one ester is represented by the formula R—(C═O)—O—R′, wherein:
R is CₙH2ₙ₊₂, n=3-5; and
R′ is CₘH₂ₘ₊₂, m=1-4.

6. The composition of claim 1, wherein the at least one ester is selected from methyl butyrate, ethyl butyrate, propyl butyrate, isopropyl butyrate, n-butyl butyrate, sec-butyl butyrate, iso-butyl butyrate, methyl valerate, ethyl valerate, propyl valerate, isopropyl valerate, n-butyl valerate, iso-butyl valerate, tert-butyl valerate, methyl caproate, ethyl caproate, propyl caproate, isopropyl caproate, n-butyl caproate, iso-butyl caproate, tert-butyl caproate, and combinations thereof.

7. The composition of claim 1, wherein the amount of solvent in the composition is at least 50% by weight of the composition.

8. The composition of claim 1, further comprising at least one co-solvent.

9. The composition of claim 8, wherein the at least on co-solvent is selected from an aliphatic hydrocarbon, an aromatic hydrocarbon, methyl formate, ethyl formate, methyl acetate, ethyl acetate, n-propyl acetate, iso-propyl acetate, n-butyl acetate, iso-butyl acetate, tert-butyl acetate, n-pentyl acetate, amyl acetate, benzyl acetate, phenyl acetate, ethylphenyl acetate, ethyl propionate, ethyl butyrate, benzyl butyrate, amyl butyrate, methyl-isobutyrate, ethyl-isobutyrate, allyl caproate, ethyl valerate, methyl-isovalerate, ethyl-isovalerate, ethyl stearate, methyl-pivalate, ethyl-pivalate, ethyl benzoate, methyl salicylate, methyl anthranilate, or combinations thereof.

10. The composition of claim 1, further comprising at least one additive selected from asphalt modifiers, curing agents, gelling agents, dehydrating agents, flame retardants, surfactants, fillers, pigments, reflective particles, fibrous materials, aggregate materials, and combinations thereof.

11. The composition of claim 10, wherein the at least one additive is selected to be reflective particles comprising aluminum metal.

12. The composition of claim 11, wherein the reflective particles comprise 5-20% by weight of the composition.

13. The composition of claim 11, further comprising a fibrous material.

14. The composition of claim 13, wherein the fibrous material comprises a polyolefin.

15. A construction material comprising the composition of claim 1.

16. The construction material of claim 15 selected from a roofing shingle, a roofing membrane, a roof coating, a paving material, a sealant, and combinations thereof.

17. The construction material of claim 16, wherein the composition forms a solar reflective surface.

18. The construction material of claim 17, wherein the solar reflective surface has a reflectivity of at least 25%.

19. A method of using the composition of claim 1, comprising:
(a) applying the composition to a surface;
(b) removing at least a portion of the solvent from the composition to form a film of the bituminous material on the surface.

20. The method of claim 19, wherein the surface is a construction surface.
